(19) United States
(12) Patent Application Publication
(10) Pub. No.: US 2026/0286580 A1
(43) Pub. Date: Sep. 24, 2026

(54) DAMPING MESH

(71) Applicant: AAC Microtech (Changzhou) Co., Ltd., Changzhou City (CN)

(72) Inventor: Wei Wei, Shenzhen (CN)

(21) Appl. No.: 19/685,154

(22) Filed: May 22, 2026

Related U.S. Application Data
(63) Continuation-in-part of application No. 17/921,623, filed on Sep. 9, 2022, now abandoned.

(30) Foreign Application Priority Data
Jun. 29, 2022 (CN) 202210762843.X

(51) Int. Cl. D03D 9/00; D03D 15/37; H04R 9/04; G10K 11/16

(52) U.S. Cl. CPC D03D 9/00; D03D 15/37; H04R 9/043; G10K 11/16

(57) ABSTRACT

Provided is a damping mesh, including at least two first wires and at least two second wires. Each first wire includes a first cylinder and at least one first protrusion formed on the first lateral surface of the first cylinder and extending away from the first lateral surface in a direction parallel to the second direction. Each second wire includes a second cylinder and at least one second protrusion formed on the second lateral surface of the second cylinder and extending away from the second lateral surface in a direction parallel to the first direction. After the first wires and the second wires are interlaced with each other, two opposite first protrusions of two adjacent first wires, and two opposite second protrusions of two adjacent second wires, cooperatively form a ventilation hole with a reduced area, which effectively improves the acoustic resistance.

### TECHNICAL FIELD

The present disclosure relates to the technical field of electro-acoustic conversion, in particular to a damping mesh adopted in sounding devices.

### BACKGROUND

With the advent of the mobile internet era, the replacement of electronic products is getting faster and faster, and people have higher and higher requirements for the performance of electronic products in all aspects, one of which is high-quality music functions. Therefore, it is necessary for sounding devices to continuously improve their performance, and high-quality sounding devices are one of the prerequisites for realizing the high-quality music function. A damping mesh attached to a sound outlet hole of the sounding device is one of the important factors for adjusting the sound quality.

In the related art, the damping mesh is woven by using a plurality of wires with circular cross-sections, so as to form a mesh with a plurality of air-permeable micropores, thereby achieving an effect of sound resistance and improve the sounding performance of the sounding device.

However, in the damping mesh of the related art, the distance between the adjacent wires is the same. Since a cross section of the wires is circular, an acoustic resistance formed among the wires is fixed. In order to improve the acoustic resistance of the damping mesh, it is necessary to increase a density of weaved wire, thereby increasing the cost of weaving.

Therefore, it is necessary to provide a new damping mesh to solve the above technical problems.

### SUMMARY

An object of the present disclosure is to overcome the above technical problems and provide a damping mesh with low cost and high acoustic resistance.

In order to achieve the above object, an embodiment of the present disclosure provides a damping mesh, including at least two first wires parallel to a first direction and spaced apart along a second direction perpendicular to the first direction, and at least two second wires parallel to the second direction and spaced apart along the first direction. Each of the first wires includes: a first cylinder having two first end faces disposed along the first direction and a first lateral surface connecting the two first end faces of the first cylinder; and at least one first protrusion formed on the first lateral surface and extending away from the first lateral surface in a direction parallel to the second direction. Each of the second wires includes: a second cylinder having two second end faces disposed along the second direction and a second lateral surface connecting the two second end faces of the second cylinder; and at least one second protrusion formed on the second lateral surface and extending away from the second lateral surface in a direction parallel to the first direction. The first cylinder and the at least one first protrusion are integrally formed in a single piece, and the second cylinder and the at least one second protrusion are integrally formed in a single piece. The first wires and the second wires are interlacedly woven with each other, by virtue of which, two opposite first protrusions of two adjacent first wires along the second direction, and two opposite second protrusions of two adjacent second wires along the first direction, cooperatively form a ventilation hole. A thickness of each of the first wires along a third direction perpendicular to the first direction and the second direction is equal to a diameter of each of the two first end faces, and a thickness of each of the second wires along the third direction is equal to a diameter of each of the two second end faces.

As an improvement, each of the first wires includes two first protrusions arranged symmetrically with respect to a central axis of the first cylinder, and the central axis of the first cylinder is parallel to the first direction.

As an improvement, each of the second wires includes two second protrusions arranged symmetrically with respect to a central axis of the second cylinder, and the central axis of the second cylinder is parallel to the second direction.

As an improvement, the first circular wire, the first wires are arranged at equal intervals along the second direction.

As an improvement, the second wires are arranged at equal intervals along the first direction.

As an improvement, each of the at least one first protrusion and the at least one second protrusion is crescent-shaped.

As an improvement, a maximum dimension of the at least one first protrusion of each of the first wires along the second direction is equal to a maximum dimension of the at least one second protrusion of each of the second wires along the first direction.

Another embodiment of the present disclosure provides a wire for a damping mesh used in a sounding device, including: a cylinder having a central axis parallel to a first direction, two end faces disposed along the central axis, and a lateral surface connecting the two end faces; and at least one protrusion extending from the lateral surface along a second direction perpendicular to the first direction. A thickness of the wire along a third direction perpendicular to the first direction and the second direction is equal to a dimeter of the cylinder; and a thickness of the wire along the second direction is equal to a sum of the diameter of the cylinder and a thickness of the at least one protrusion protruding from the cylinder.

As an improvement, the wire includes two protrusions extending from the lateral surface along the second direction. The two protrusions are arranged symmetrically about the central axis, and the thickness of the wire along the second direction is equal to a sum of the diameter of the cylinder and thicknesses of the two protrusions protruding from the cylinder.

Compared with the related art, in the damping mesh of the present disclosure, the first wire parallel to a first direction includes a first cylinder and at least one first protrusion formed on the first lateral surface of the first cylinder and extending away from the first lateral surface in a direction parallel to the second direction, and the second wire includes a second cylinder and at least one second protrusion formed on the second lateral surface of the second cylinder and extending away from the second lateral surface in a direction parallel to the first direction, so as to increase a width of the first wire along a direction parallel to the second direction and a width of the second wire along a direction parallel to the first direction. Therefore, after the first wires and the second wires are interlaced with each other, two opposite first protrusions of two adjacent first wires along the second direction, and two opposite second protrusions of two adjacent second wires along the first direction, cooperatively form a ventilation hole with a reduced area. In addition, the integrated forming structure of the cylinder and the protrusion can enhance the structural strength of the wires. Moreover, by limiting a thickness of the first wire being equal to a diameter of the first end face, and a thickness of the second wire being equal to a diameter of the second end face, it is also ensured that the thickness of the damping mesh remains unchanged. In conclusion, when preparing the damping mesh according to the embodiments of the present disclosure with the same area and the same number as that in the related art, the occupied area of the wires is increased while the area of the ventilation holes is reduced, which effectively improves the acoustic resistance. There is no need to reduce the area of ventilation holes by increasing the number of the first wires and the second wires to achieve the purpose of improving acoustic resistance, so the production cost is effectively lowered, and the structural strength is also guaranteed simultaneously.

### BRIEF DESCRIPTION OF THE DRAWINGS

In order to illustrate technical solutions of the embodiments of the present disclosure more clearly, the accompanying drawings required in the embodiments will be briefly introduced below. Obviously, the accompanying drawings in the following description are only some embodiments of the present disclosure. For those of ordinary skill in the art, other accompanying drawings may also be obtained from these accompanying drawings without creative effort.

FIG. 1 is an isometric view of a damping mesh in accordance with an embodiment of the present disclosure.

FIG. 2 is an enlarged view of Portion E of the damping mesh shown in FIG. 1.

FIG. 3 is a top view of the damping mesh in FIG. 1.

FIG. 4 is a cross-sectional view of the damping mesh in FIG. 3 taken along a line A-A.

FIG. 5 is a cross-sectional view of the damping mesh in FIG. 3 taken along a line B-B.

FIG. 6 is an isometric view of a wire for weaving the damping mesh shown in FIG. 1.

### DETAILED DESCRIPTION OF THE EMBODIMENTS

The technical solutions in the embodiments of the present disclosure will be clearly and completely described below with reference to the drawings in the embodiments of the present disclosure. Obviously, the described embodiments are only a part of the embodiments of the present disclosure, but not all of the embodiments. Based on the embodiments of the present disclosure, all other embodiments obtained by those of ordinary skill in the art without creative efforts shall fall within the protection scope of the present disclosure.

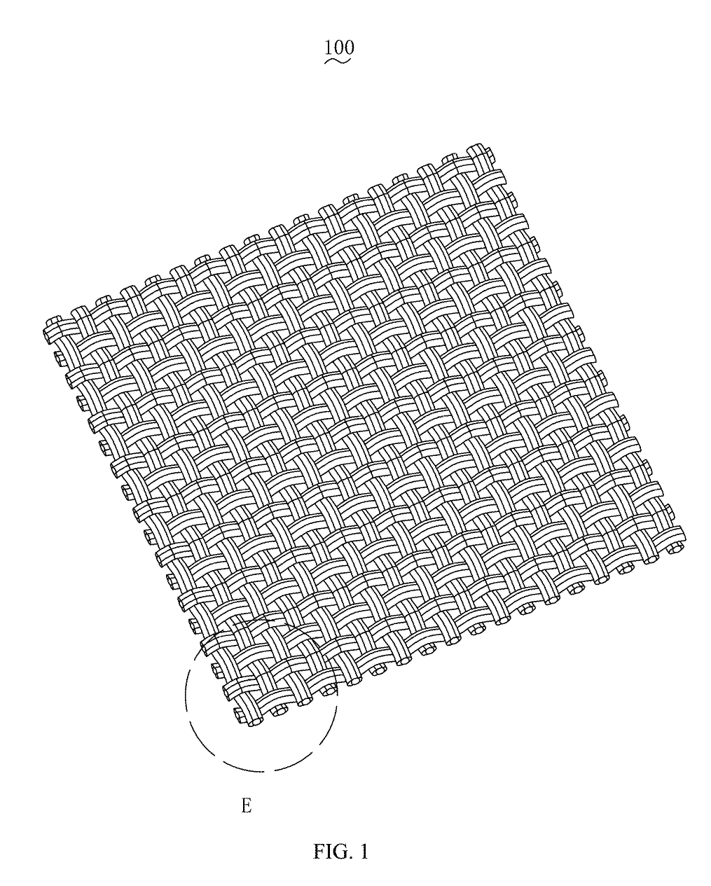

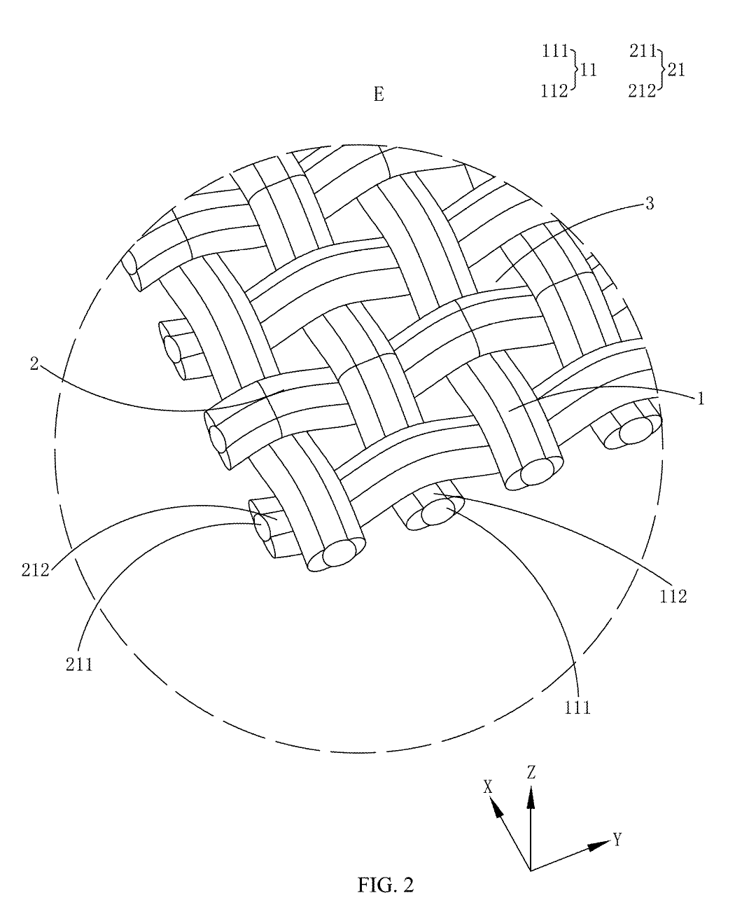

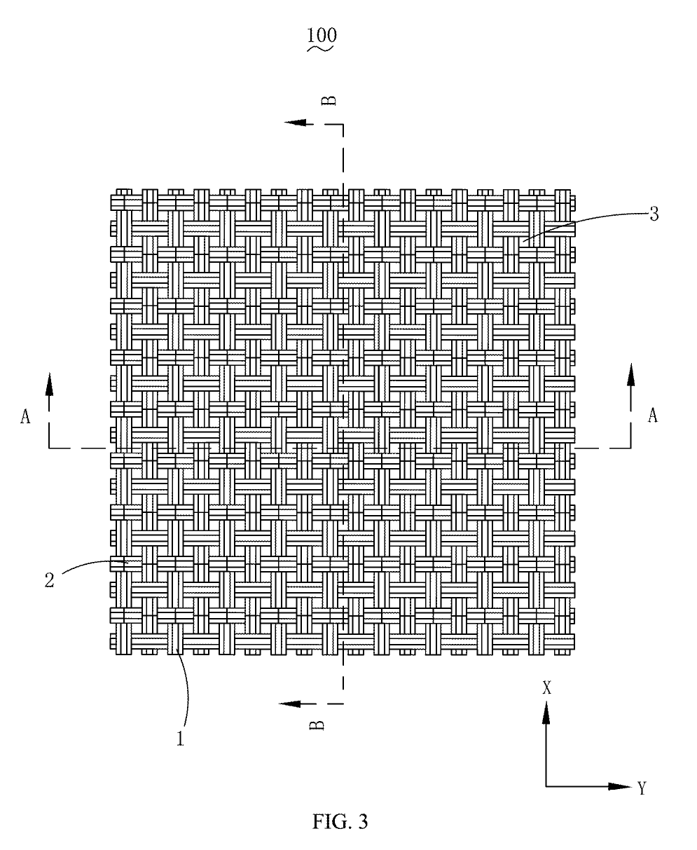

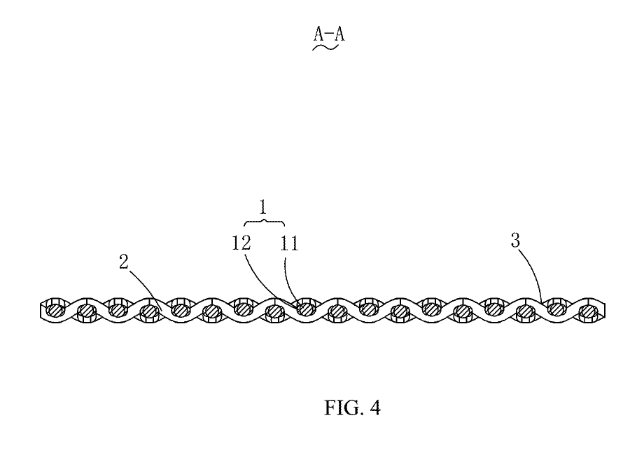

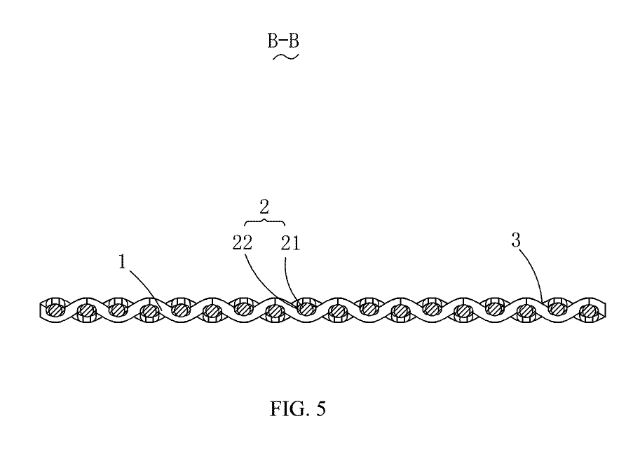

Referring to FIGS. 1-5, the present disclosure provides a damping mesh, including at least two first wires 1 parallel to a first direction X and spaced apart along a second direction Y, and at least two second wires 2 parallel to the second direction Y and spaced apart along the first direction X. Each first wire 1 includes a first cylinder 11 and at least one first protrusion 12. The first cylinder 11 has two first end faces 111 disposed along the first direction X and a first lateral surface 112 connecting the two first end faces 111 of the first cylinder 11. The first protrusion 12 is formed on the first lateral surface 112 and extends away from the first lateral surface 112 in a direction parallel to the second direction Y. Each second wire 2 includes a second cylinder 21 and at least one second protrusion 22. The second cylinder 21 has two second end faces 211 disposed along the second direction Y and a second lateral surface 212 connecting the two second end faces 211 of the second cylinder 21. The second protrusion 22 is formed on the second lateral surface 212 and extends away from the second lateral surface 212 in a direction parallel to the first direction X. The first wires 1 and the second wires 2 are interlacedly weaved with each other, by virtue of which, two opposite first protrusions 12 of two adjacent first wires 1 along the second direction Y, and two opposite second protrusions 22 of two adjacent second wires 2 along the first direction X, cooperatively form a ventilation hole 3. Namely, every two adjacent first wires 1 are provided with two oppositely arranged first protrusions 12 along the second direction Y, and every two adjacent second wires 2 are provided with two oppositely arranged second protrusions 22 along the first direction X. The two first protrusions 12 and the two second protrusions 22 jointly define a ventilation hole 3.

In some embodiments, the number of the first wires 1 and the number of the second wires 2 may be 3, 4, 5, or the like, which is not limited in the embodiments of the present disclosure.

In some embodiments, a plurality of first wires 1 is arranged perpendicular to a plurality of second wires 2 to weave and form a damping mesh 100. That is to say, the first direction X is perpendicular to the second direction Y.

It should be noted that the cylinder in the embodiments of the present disclosure refers to a three-dimensional columnar structure with two circular end faces of the same size, a smooth curved lateral surface, and a uniform thickness from one end face to the other end face.

In the embodiments of the present disclosure, the first wire 1 parallel to the first direction X includes a first cylinder 11 and at least one first protrusion 12 formed on the first lateral surface 112 of the first cylinder 11 and extending away from the first lateral surface 112 in a direction parallel to the second direction Y, and the second wire 2 includes a second cylinder 21 and at least one second protrusion 22 formed on the second lateral surface 212 of the second cylinder 21 and extending away from the second lateral surface 212 in a direction parallel to the first direction X. The first protrusion 12 increases a width of the first wire 1 along a direction parallel to the second direction Y, the second protrusion 22 increases a width of the second wire 2 along a direction parallel to the first direction X. Therefore, after the first wires 1 and the second wires 2 are interlaced with each other, two opposite first protrusions 12 of two adjacent first wires 1 along the second direction Y, and two opposite second protrusions 22 of two adjacent second wires 2 along the first direction X, cooperatively form a ventilation hole 3 with a reduced area. That is, by increasing the width of the first wire 1 and the width of the second wire 2, when weaving the damping mesh 100 with the same area and the same number of wires, the area occupied by the wires is increased, and the area of the ventilation holes 3 is reduced. Therefore, the acoustic resistance is effectively improved, and the object of increasing the acoustic resistance without increasing the number of the first wires 1 and the number of the second wires 2 to reduce the area of the ventilation holes 3 can be achieved, thereby effectively reducing the production cost.

In some embodiments, the first cylinder 11 and the at least one first protrusion 12 are integrally formed in a single piece, and/or the second cylinder 21 and the at least one second protrusion 22 are integrally formed in a single piece. The integral structure molding arrangement enables high structural strength and saves the cost.

In some embodiments, a thickness of the first wire 1 along a third direction Z is equal to a diameter of the first end face 111, and a thickness of the second wire 2 along the third direction Z is equal to a diameter of the second end face 211.

The third direction Z is perpendicular to both the first direction X and the second direction Y. Namely, in the embodiments of the present disclosure, the first direction X, the second direction Y and the third direction Z are mutually perpendicular to one another.

In the embodiments of the present disclosure, by limiting a thickness of the first wire 1 being equal to a diameter of the first end face 111, and a thickness of the second wire 2 being equal to a diameter of the second end face 211, it is ensured that the thickness of the damping mesh 100 remains unchanged, which can reduce the interweaving difficulty of the first wires 1 and the second wires 2, and further improve the installation performance and structural compatibility.

In some embodiments, a plurality of the first wires 1 are arranged at equal intervals along the second direction Y, and/or a plurality of the second wires 2 are arranged at equal intervals along the first direction X, so that the positions of the ventilation holes 3 of the damping mesh 100 woven by the first wires 1 and the second wires 2 are evenly distributed, in which the effect of increasing the acoustic resistance of the damping mesh 100 is consistent, and the use is good.

In some embodiments, each of the first wires 1 includes two first protrusions 12 respectively arranged on two sides of the first lateral surface 112 of the first cylinder 11 along the second direction Y, and/or each of the second wires 2 includes two second protrusions 22 respectively arranged on two sides of the second lateral surface 212 of the second cylinder 21 along the first direction X.

Further, in some embodiments, the two first protrusions 12 of the same first wire 1 are arranged symmetrically with respect to a central axis of the first cylinder 11, and/or the two second protrusions 22 of the same second wire 2 are arranged symmetrically with respect to a central axis of the second cylinder 21.

The central axis of the first cylinder 11 is parallel to the first direction X, and the central axis of the second cylinder 21 is parallel to the second direction Y.

In the embodiments of the present disclosure, by arranging two first protrusions 12 symmetrically about the central axis of the first cylinder 11 and two second protrusions 22 symmetrically about the central axis of the second cylinder 21, the overall structure of the wires is more balanced and uniform. This symmetric layout makes the stress distribution of the first wires 1 and the second wires 2 more reasonable during interweaving, effectively avoids unilateral stress concentration and structural deflection, greatly improves the weaving regularity and assembly convenience of the damping mesh 100, and lowers the weaving and forming difficulty. Meanwhile, the symmetrically arranged protrusions can form ventilation holes 3 with consistent size and uniform distribution, ensuring uniform air permeability and stable acoustic resistance of the whole product. In addition, the symmetric structure further enhances the overall structural stability, compression resistance and deformation resistance of the damping mesh 100, and maintains stable damping and noise reduction performance in long-term use.

In some embodiments, the first protrusion 12 and the second protrusion 22 are both crescent-shaped, which is convenient to increase an overall width of the wire, thereby increasing an area occupied by the wires, and reducing the permeability area is reduced, and obtain a higher sound resistance.

In some embodiments, the structure of the first wire 1 and the structure of the second wire 2 are the same. The damping mesh 100 formed after weaving in this way has high strength and good use effect.

In some embodiments, a maximum dimension of the first protrusion 12 of the first wire 1 along the second direction Y is equal to a maximum dimension of the second protrusion 22 of the second wire 2 along the first direction X.

In the embodiments of the present disclosure, by arranging the maximum dimension of the first protrusion 12 along the second direction Y being equal to that of the second protrusion 22 along the first direction X, the formed ventilation holes 3 can have regular and uniform shapes and consistent inner space, thereby effectively unifying the air permeability and acoustic resistance of the whole damping mesh 100, and improving forming consistency, and ensuring stable and uniform damping and noise reduction performance of products in all positions.

Compared with the prior art, in the damping mesh 100 of the present disclosure, the first wire 1 parallel to a first direction X includes a first cylinder 11 and at least one first protrusion 12 formed on the first lateral surface 112 of the first cylinder 11 and extending away from the first lateral surface 112 in a direction parallel to the second direction Y, and the second wire 2 includes a second cylinder 21 and at least one second protrusion 22 formed on the second lateral surface 212 of the second cylinder 21 and extending away from the second lateral surface 212 in a direction parallel to the first direction X, so as to increase a width of the first wire 1 along a direction parallel to the second direction Y and a width of the second wire 2 along a direction parallel to the first direction X. Therefore, after the first wires 1 and the second wires 2 are interlaced with each other, two opposite first protrusions 12 of two adjacent first wires 1 along the second direction Y, and two opposite second protrusions 22 of two adjacent second wires 2 along the first direction X, cooperatively form a ventilation hole 3 with a reduced area. In addition, the integrated forming structure of the cylinder and the protrusion can enhance the structural strength of the wires. Moreover, by limiting a thickness of the first wire 1 being equal to a diameter of the first end face 111, and a thickness of the second wire 2 being equal to a diameter of the second end face 211, it is also ensured that the thickness of the damping mesh 100 remains unchanged. In conclusion, when preparing the damping mesh 100 provided by the embodiments of the present disclosure with the same area and the same number as that in the related art, the occupied area of the wires is increased while the area of the ventilation holes 3 is reduced, which effectively improves the acoustic resistance. There is no need to reduce the area of ventilation holes 3 by increasing the number of the first wires 1 and the second wires 2 to achieve the purpose of improving acoustic resistance, so the production cost is effectively lowered, and the structural strength is also guaranteed simultaneously.

The present disclosure further provides a wire, which is used for the damping mesh 100 in a sounding device described in the above embodiments.

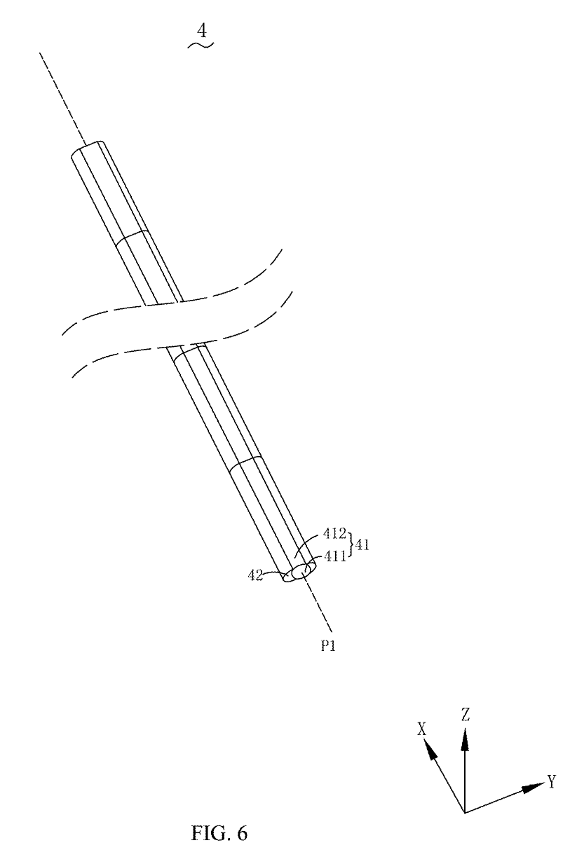

In some embodiments, the wire 4 is an unwoven state of one of the first wires 1 and the second wires 2 in the damping mesh 100 according to the foregoing embodiments. Specifically, as shown in FIG. 6, the wire 4 includes: a cylinder 41 having a central axis P1 parallel to a first direction X, two end faces 411 disposed along the central axis P1, and a lateral surface 412 connecting the two end faces 411; and at least one protrusion 42 extending from the lateral surface 412 along a second direction Y perpendicular to the first direction X. A thickness of the wire 4 along a third direction Z perpendicular to the first direction X and the second direction Y is equal to a dimeter of the cylinder 41; and a thickness of the wire 4 along the second direction Y is equal to a sum of the diameter of the cylinder 41 and a thickness of the at least one protrusion 42 protruding from the cylinder 41.

With further reference to FIG. 6, the wire 4 includes two protrusions 42 extending from the lateral surface 412 along the second direction Y, the two protrusions 42 are arranged symmetrically about the central axis P1, and the thickness of the wire 4 along the second direction Y is equal to a sum of the diameter of the cylinder 41 and thicknesses of the two protrusions 42 protruding from the cylinder 41.

Described above are only preferred embodiments of the present disclosure, and are not intended to limit the present disclosure. Any equivalent structure or equivalent process transformation made by using the contents of the description and accompanying drawings of the present disclosure, or directly or indirectly applied in other related technical fields, are similarly included in the protection scope of the present disclosure.

What is claimed is:

1. A damping mesh, comprising:
at least two first wires parallel to a first direction and spaced apart along a second direction perpendicular to the first direction, each of the first wires comprising:
a first cylinder having two first end faces disposed along the first direction and a first lateral surface connecting the two first end faces of the first cylinder; and
at least one first protrusion formed on the first lateral surface and extending away from the first lateral surface in a direction parallel to the second direction;
at least two second wires parallel to the second direction and spaced apart along the first direction, each of the second wires comprising:
a second cylinder having two second end faces disposed along the second direction and a second lateral surface connecting the two second end faces of the second cylinder; and
at least one second protrusion formed on the second lateral surface and extending away from the second lateral surface in a direction parallel to the first direction;
wherein,
the first cylinder and the at least one first protrusion are integrally formed in a single piece;
the second cylinder and the at least one second protrusion are integrally formed in a single piece;
the first wires and the second wires are interlacedly woven with each other, by virtue of which, two opposite first protrusions of two adjacent first wires along the second direction, and two opposite second protrusions of two adjacent second wires along the first direction, cooperatively form a ventilation hole;
a thickness of each of the first wires along a third direction perpendicular to the first direction and the second direction is equal to a diameter of each of the two first end faces; and
a thickness of each of the second wires along the third direction is equal to a diameter of each of the two second end faces.

2. The damping mesh as described in claim 1, comprising, for each of the first wires, two first protrusions arranged symmetrically with respect to a central axis of the first cylinder, wherein, the central axis of the first cylinder is parallel to the first direction.

3. The damping mesh as described in claim 1, comprising, for each of the second wires, two second protrusions arranged symmetrically with respect to a central axis of the second cylinder, wherein, the central axis of the second cylinder is parallel to the second direction.

4. The damping mesh as described in claim 1, wherein the first wires are arranged at equal intervals along the second direction.

5. The damping mesh as described in claim 1, wherein the second wires are arranged at equal intervals along the first direction.

6. The damping mesh as described in claim 1, wherein each of the at least one first protrusion and the at least one second protrusion is crescent-shaped.

7. The damping mesh as described in claim 1, wherein a maximum dimension of the at least one first protrusion of each of the first wires along the second direction is equal to a maximum dimension of the at least one second protrusion of each of the second wires along the first direction.

8. A wire for a damping mesh used in a sounding device, comprising:
a cylinder having a central axis parallel to a first direction, two end faces disposed along the central axis, and a lateral surface connecting the two end faces; and
at least one protrusion extending from the lateral surface along a second direction perpendicular to the first direction;
wherein a thickness of the wire along a third direction perpendicular to the first direction and the second direction is equal to a dimeter of the cylinder; and a thickness of the wire along the second direction is equal to a sum of the diameter of the cylinder and a thickness of the at least one protrusion protruding from the cylinder.

9. The wire as described in claim 8, comprising two protrusions extending from the lateral surface along the second direction, wherein the two protrusions are arranged symmetrically about the central axis, and the thickness of the wire along the second direction is equal to a sum of the diameter of the cylinder and thicknesses of the two protrusions protruding from the cylinder.
